(19) United States
(12) Patent Application Publication
(10) Pub. No.: US 2006/0145885 A1
(43) Pub. Date: Jul. 6, 2006

(54) Multi-function meter

(76) Inventors: Philip M. Goulis, Middlefield, CT (US); Peter A. Staniforth, Killingworth, CT (US)

Correspondence Address: ALIX YALE & RISTAS LLP, 750 MAIN STREET, SUITE 1400, HARTFORD, CT, 06103, US

(21) Appl. No.: 11/017,031

(22) Filed: Dec. 20, 2004

(51) Int. Cl. G08B 3/00

(52) U.S. Cl. 340/691.6

(57) ABSTRACT

A multi-function meter system for measuring multiple environmental parameters includes a hand-held meter and an environmental probe for sensing a selected environmental parameter. The meter includes a housing, an electronic assembly mounted within the housing, a display screen, an operator pad, and multiple data ports. The electronic assembly includes a microprocessor and a memory device having an operating system stored therein. The operating system either identifies the environmental parameter sensed by the environmental probe or transmits a query to the display screen requesting that the environmental parameter be identified to the operating system through the operator pad. The operating system then provides at least one measured value of the identified environmental parameter on the display screen.

### BACKGROUND OF THE INVENTION

This invention relates generally to electronic instruments for measuring a specified parameter. More particularly, the present invention relates to hand-held electronic instruments for measuring parameters such as temperature, humidity, pressure, and air flow.

A mechanic or technician working in the HVAC/R industry today is faced with ever-increasing demands by both customers and government regulations to maintain system efficiency in order to reduce energy consumption. To achieve this goal, the mechanic must obtain critical information regarding the HVAC/R system performance relative to design parameters, and use that information to adjust the system for peak performance.

In addition, as the capacity and capabilities of computers, manufacturing equipment and appliances have improved, the operating environment temperature and humidity requirements for such equipment has generally become increasingly stringent. If such equipment is subjected to heat and/or humidity in excess of a specified value, the real-time performance of the equipment is generally significantly degraded. In addition, continued exposure to excessive heat and/or humidity can also accelerate aging of the equipment, leading to premature failure. For some of this equipment (e.g. computers) this problem is exacerbated by the requirement to remove significant quantities of heat generated by the equipment itself.

It is known that a wide range of substantially different parameters must be measured to determine the quality of the environment and to measure the performance of the apparatus tasked with maintaining a proper environment. However, common tools available on the market are dedicated to a single parameter measurement, such as temperature or relative humidity, and thus provide the mechanic with but one of several particular elements of system performance needed. Consequently, the mechanic needs to carry several instruments to obtain sufficient data to properly diagnose and service the HVAC/R equipment.

### SUMMARY OF THE INVENTION

Briefly stated, the invention in a preferred form is a multi-function meter system and a method of measuring multiple environmental parameters with a single multi-function meter system.

The multi-function meter comprises a hand-held meter including a housing, an electronic assembly mounted within the housing, a display screen, an operator pad, and multiple data ports. The electronic assembly includes a circuit board and a microprocessor and a memory device connected to the circuit board. The memory device has an operating system stored therein. The display screen, the operator pad, and the data ports are all connected to the circuit board. An environmental probe for sensing a selected environmental parameter may connected to one of the data ports. The operating system either identifies the environmental parameter sensed by the environmental probe or transmits a query to the display screen requesting that the environmental parameter be identified to the operating system through the operator pad. The operating system then provides at least one measured value of the identified environmental parameter on the display screen.

The operator pad preferably includes a POWERtouch control button, an UP ARROW touch control button, a DOWN ARROW touch control button, a CANCEL touch control button, an ENTER touch control button, and a plurality of multi-use numeric/function keys. The data ports include two universal ports and three temperature ports, where each of the universal ports is a 5 pin DIN connector.

The environmental probe may be a temperature probe, a humidity probe, a pressure probe, or an airflow probe. For a humidity probe, the measured value displayed on the display screen may be selected from wet bulb value, dry bulb value, specific humidity value, % relative humidity value, enthalpy value, and dew point value. For a pressure probe, the measured value displayed on the display screen has a pressure range of 0 to 1000 psi.

The environmental probe may be a special function probe having a jack for connecting the probe to one of the meter universal data ports, at least one environmental sensor, a microprocessor and interface circuitry connecting the sensor, the microprocessor and the jack.

The method of measuring multiple environmental parameters with a single multi-function meter system includes the steps of transmitting a signal from the environmental probe to the meter, identifying the environmental parameter within the meter microprocessor, computing at least one measured value specific to the identified environmental parameter with the operating system, and displaying the measured value of the identified environmental parameter on the display screen.

It is an object of the invention to provide a multi-function meter capable of measuring multiple HVAC/R system parameters.

It is also an object of the invention to provide a multi-function meter that it enables the user to see HVAC/R system conditions based on both measured and calculated display values.

It is further an object of the invention to provide a multi-function meter that may be customized to perform specific tasks by the selection of specific measurement probes.

Other objects and advantages of the invention will become apparent from the drawings and specification.

### BRIEF DESCRIPTION OF THE DRAWINGS

The present invention may be better understood and its numerous objects and advantages will become apparent to those skilled in the art by reference to the accompanying drawings in which:

FIG. 1 is a front view of a multi-function meter in accordance with the invention;

FIG. 2 is a rear view of the multi-function meter of FIG. 1;

FIG. 3 is a cross-sectional view taken along line 3-3 of FIG. 1;

FIG. 4 is a flow diagram of the main operating program of the multi-function meter of FIG. 1;

FIG. 5 is a flow diagram of the unit initialization routine of multi-function meter of FIG. 1;

FIG. 6 is a flow diagram of the bootloader routine of multi-function meter of FIG. 1;

FIG. 7 is a flow diagram of the read keypad routine of multi-function meter of FIG. 1;

FIG. 8 is a flow diagram of the update display routine of multi-function meter of FIG. 1;

FIG. 9 is a flow diagram of the PC link routine of multi-function meter of FIG. 1;

FIG. 10 is a flow diagram of the multi-function meter—special function probe communication routine; and

FIG. 11 is a schematic diagram of a special function probe in accordance with the invention.

### DETAILED DESCRIPTION OF THE PREFERRED EMBODIMENT

With reference to the drawings wherein like numerals represent like parts throughout the several figures, a multi-function meter in accordance with the present invention is generally designated by the numeral 10.

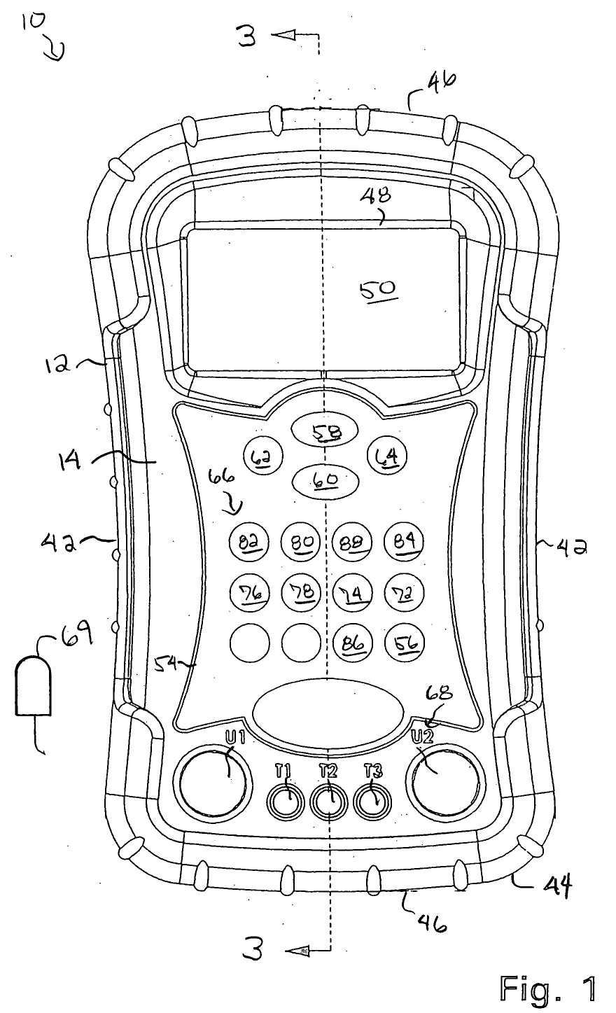

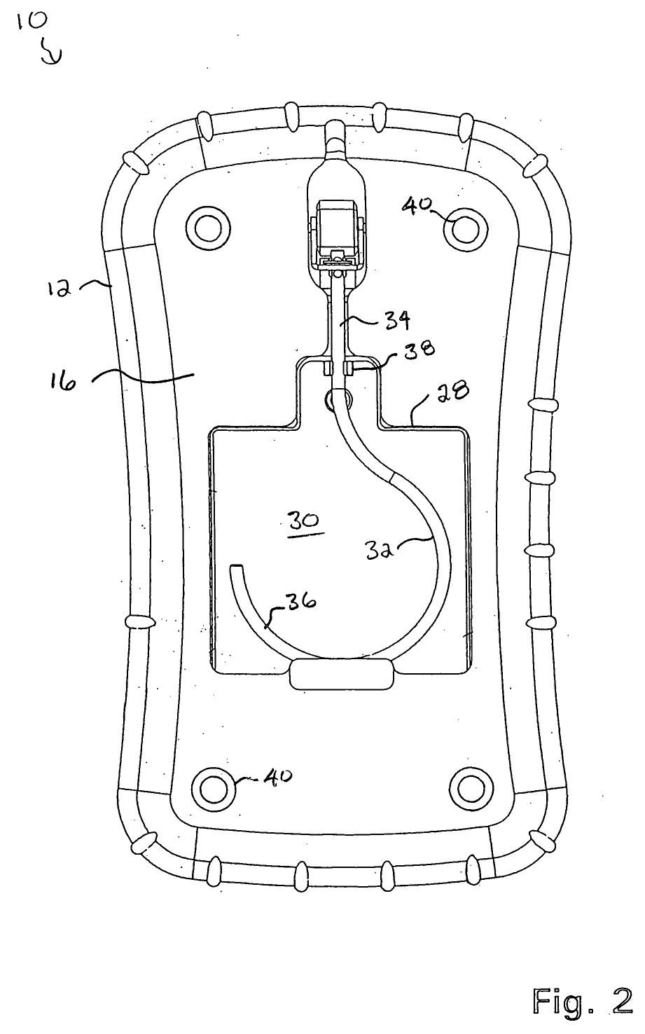

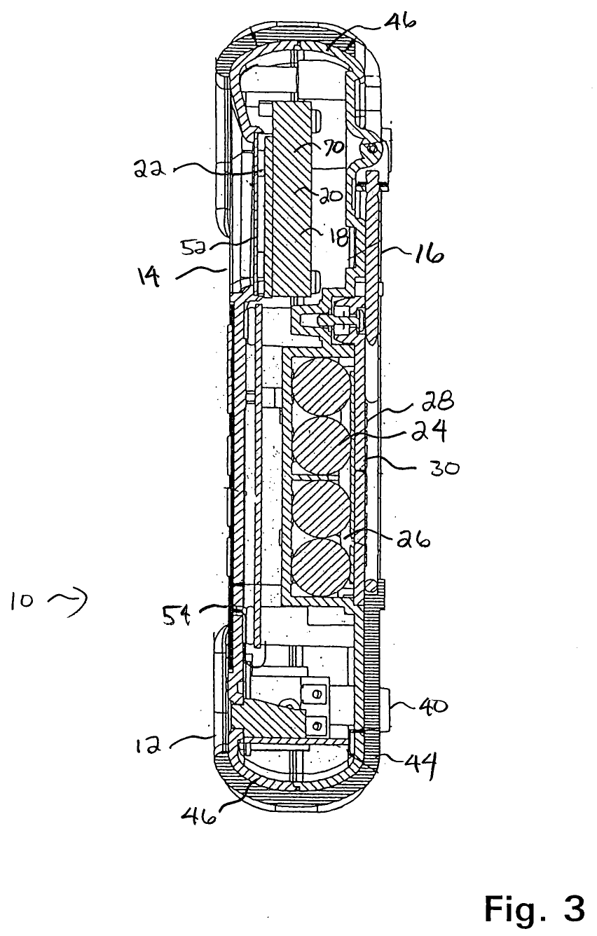

With reference to FIGS. 1, 2 and 3, the meter 10 includes a housing 12 having a front face 14 and an oppositely disposed rear face 16. An electronic assembly 18 including a microprocessor 20 mounted on a circuit board 22 is housed in within the housing 12. Four conventional AA batteries 24 may be inserted into the battery compartment 26 of the housing 12, through an opening 28 in the rear face 16, to provide a renewable internal power source for the electronic assembly 18. A battery door 30 normally covers opening 28, to prevent entry of dirt, etc. into the interior of the housing 12. A hook member 32 has a straight end portion 34 pivotally mounted to the housing rear face 16 and a hook portion 36 that may be used to suspend the meter 10 from a pipe, for example. A catch 38 mounted to the housing rear face 16 engages the hook member 32 to hold the hook portion 36 against the housing rear face 16 when the hook member 32 is not being used to hang the meter 10. To facilitate use of the meter 10 while it is resting on a horizontal work surface, feet 40 on each corner of the meter 10 extends from the surface of the rear face 16 such that the feet 40 engage the work surface. This prevents the meter 10 from resting on the hook member 32, the catch 38, or any protruding portion of the rear face 16, and wobbling about such point or line of engagement.

The two side panels 42 of the meter 10 have an arcuate shape, the housing 12 having a mid-section that is narrower than the upper and lower sections, providing an ergonomic shape that is easier to grasp. Preferably, a boot 44 composed of resilient material covers at least portions of the side panels 42 and the end panels 46. The boot 44 facilitates gripping the meter 10 and also reduces the probability of damage to the meter 10, should it be dropped. Preferably, the meter 10 may withstand a single drop from a distance of twelve feet onto a hard surface without sustaining damage.

The front face 14 has an opening 48 for viewing a liquid crystal display screen 50 mounted on the circuit board 22. A sealed viewing window 52 provides a fluid tight seal which prevents the introduction of liquid and other materials through the display opening 48. An operator pad 54 is mounted to the front face 14 and also provides a fluid tight seal which prevents the introduction of liquid and other materials into the interior of the housing 12. Preferably, the operator pad 54 includes a POWER touch control button 56, an UP ARROW touch control button 58, a DOWN ARROW touch control button 60, a CANCEL touch control button 62, an ENTER touch control button 64 and multiple multi-use numeric/function keys 66. The front face 14 also includes multiple ports 68 or jacks that provide interfaces for a variety of conventional and propriety environmental detectors. Preferably, the ports 68 include two universal ports U1, U2 and three temperature ports T1, T2, T3.

The universal ports U1, U2 use a 5 pin DIN connector and are capable of accepting signals from a variety of different environmental probes 69. As defined herein, an environmental probe is any probe that is capable of sensing an environmental parameter. For example, the meter 10 is capable of (but not limited to) receiving input from temperature, humidity, pressure, and vane type airflow probes. With respect to humidity measurement, the meter 10 is capable of displaying the following psychometric values: wet bulb, dry bulb, specific humidity, % relative humidity, enthalpy, and dew point, utilizing a conventional humidity, for example the Cooper-Atkins 5029 humidity probe. With respect to pressure measurement, the meter 10 is capable of measuring fluids in the pressure range 0 to 1000 psi, fully encompassing the pressure range of typical refrigeration/air conditioning refrigerants. The meter 10 has an altitude compensation feature that may be performed by the user, allowing the altitude to be adjusted from −50 to 15,000 ft, with the default being sea level. The meter 10 is compatible with pressure transducers in two pressure measurement ranges, 0 to 500 psi and 0 to 1000 psi. The transducer reading can be “zeroed out” by the user. The microprocessor is programmed to automatically recognize and utilize most conventional probes, allowing the meter 10 to convert the input signal received and display the appropriate units and format for the parameter being measured. The probes are powered by the battery power source 24, through the universal ports U1, U2.

The temperature ports T1, T2, T3 accept conventional 10K thermistor probes, for example thermistor probes of the type offered by Cooper-Atkins. The operating specifications for some of the environmental probes that may be used with the meter 10 are provided in Table 1.

TABLE 1

| | |
|---|---|
| Temperature (Jacks T1, T2, & T3) | |
| Measurement Range | −58° F. to 302° F. |
| Accuracy | ±0.3% Reading |
| Display Resolution | 0.1 Degree |
| Relative Humidity (RH) Probe | |
| Measurement Range | 0% to 99% RH |
| Accuracy | ±2% RH |
| Display Resolution | 1% RH |
| Dry-Bulb | |
| Temperature Range | −40° F. to 185° F. |
| Accuracy | ±0.3% Reading |
| Display Resolution | 0.1 Degree |
| Pressure Probe | |
| 0 to 500 PSI Accuracy | ±1% Full-Scale |
| 0 to 1000 PSI Accuracy | ±1% Full-Scale |

The display screen 50 provides eight (8) lines, with each of the lines having twenty (20) characters. The display screen 50 has a backlight that may be turned on and off. The display screen contrast can also be adjusted. When the meter 10 is turned on, the battery capacity is displayed. The software stored in the microprocessor memory 70 automatically recognizes most conventional probes, when they are plugged into one of the ports 68, and displays current readings of the probe in a “normal” mode on the display screen 50.

In the normal mode, a menu generated by the microprocessor enables the multipurpose keys or buttons 66 of the operator pad 54 to provide the desired display of a measured environmental parameter. For example, if temperature probes are plugged into at least two of the temperature jacks T1, T2, T3, pressing the DELTA/8 button 72 will cause the differential temperature between two active temperature inputs to be displayed (T1/T2, T1/T3, T2/T3). Pressing the AVG/7 button 74 causes an average of two sequential temperature measurements to be displayed, along with the time the initial (first) input has been active. Pressing the MIN/5 button 76 or MAX/6 button 78 causes the minimum or maximum values of active inputs to be displayed along with the time the initial input(s) has been active. Pressing the SH/2 button 80 causes a calculated value of superheat or sub-cooling to be displayed, depending on the temperature and pressure inputs. Temperature input T1 is associated with pressure input from universal port U1 and temperature input T2 is associated with pressure input from universal port U2, with the superheat/sub-cooling being calculated from either the T1/U1 or the T2/U2 inputs. The display screen indicates the calculated superheat/sub-cooling in ° F. or ° C. and provides either a “SUPERHEAT” or “SUB-COOLING” label. Pressing the PSYCH/1 button 82 will display a list of the wet bulb temperature in ° F. or ° C.; the dry bulb temperature in ° F. or ° C.; the specific humidity; the percent relative humidity; the enthalpy; and the dew point in ° F. or ° C., based on inputs from U1 and U2.

Pressing the MENU/4 button 84 allows various user preferences to be accessed, including: Adjust Contrast, View GL100 Log, I-button Reader, Pressure/Temperature Charts, Display/Hide Elapsed Time, Disable/Enable Auto Shutoff, Setup. The desired menu feature initiated by selecting the feature with the UP/DOWN arrow buttons 58, 60 and pressing the ENTER button 64. Contrast sets the display screen contrast for use in bright or low light conditions. I-button reader allows refrigerant information to be downloaded into the microprocessor memory. Pressure/Temperature charts allows the user to choose one of the stored refrigerants and scroll through related pressure/temperature data. Display/Hide Elapsed Time displays or hides the time that probe has been active in “Normal” display. Initiating Setup causes a sub menu to be displayed. The sub menu includes: Set altitude—sets the altitude of the instrument use location; Set units (English or Metric); Temperature calibration—field calibration for temperature measurement; Zero probe P1—set display for pressure transducer on U1 to “0”; and Zero probe P2—set display for pressure transducer on U2 to “0”.

Pressure-temperature data for fifteen (15) refrigerants is permanently stored in the microprocessor memory 70. In addition, pressure-temperature data for five (5) reprogramable refrigerants may be stored in the microprocessor memory 70. Data for the reprogramable refrigerants is downloaded to the microprocessor 20 via universal port U1 by an I-button or similar apparatus.

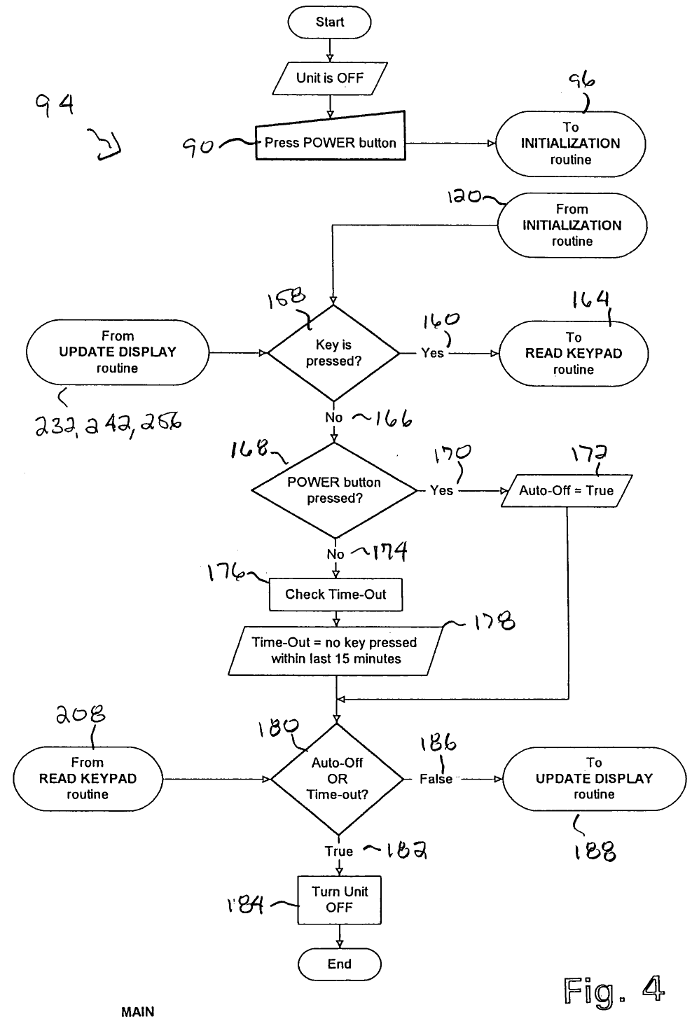

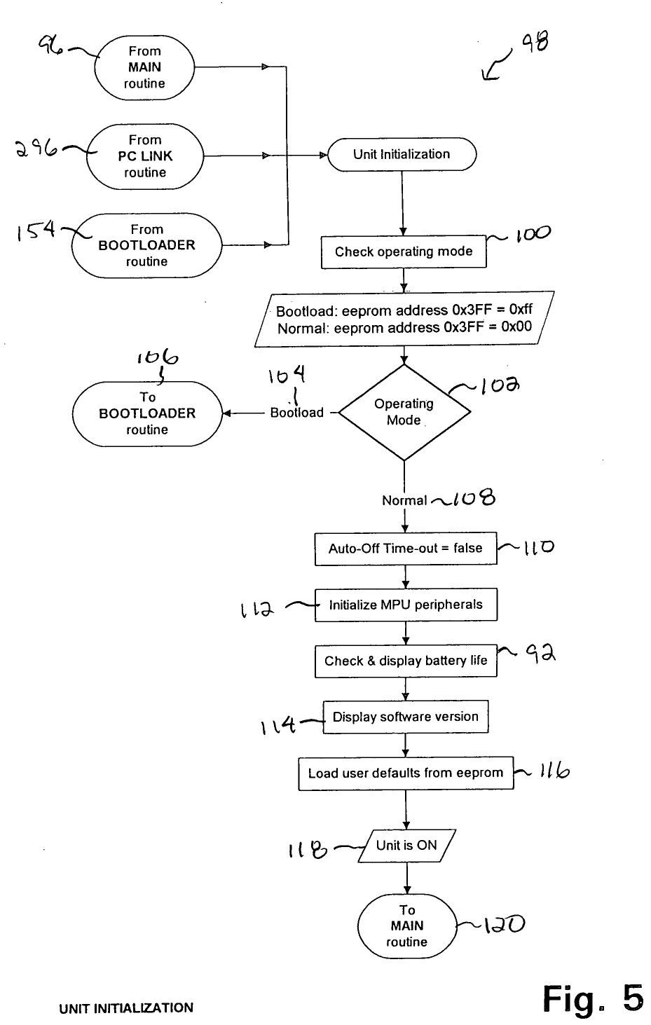

With reference to FIG. 4, the meter 10 is generally left off when not in use. Accordingly, the meter 10 must first be turned on before it may be used by pressing and holding 90 the POWER button 56 until the display shows the Cooper™ logo and the remaining battery life indicator 92 (FIG. 5). Pressing the POWER button 56 to turn on the meter 10 initiates the Main program or routine 94 of the operating software stored in the microprocessor memory 70. The Main routine 94 immediately starts 96 the Initialization routine 98.

With reference to FIG. 5, the Initialization routine 98 first checks 100 the operating mode of the meter 10 by examining 102 EEPROM address 0×3FF. If “O×ff” is stored in EEPROM address 0×3FF, the meter 10 is in the Bootload mode 104, and the Bootloader routine 105, explained in detail below, is initiated 106. If any value less than “O×ff” is stored in EEPROM address 0×3FF, the meter 10 is in the Normal mode 108.

If the meter 10 is in the Normal mode, the Initialization routine 98 stores 110 “false” in the Auto-Off Time-Out memory address, initializes 112 the MPU peripherals, checks and displays 92 the remaining battery life, displays 114 the current version of the software, and loads 116 any user defaults stored in the EEPROM. At this point, the meter 10 is fully turned on 118, and the Initialization routine 98 exits 120 to the Main routine 94.

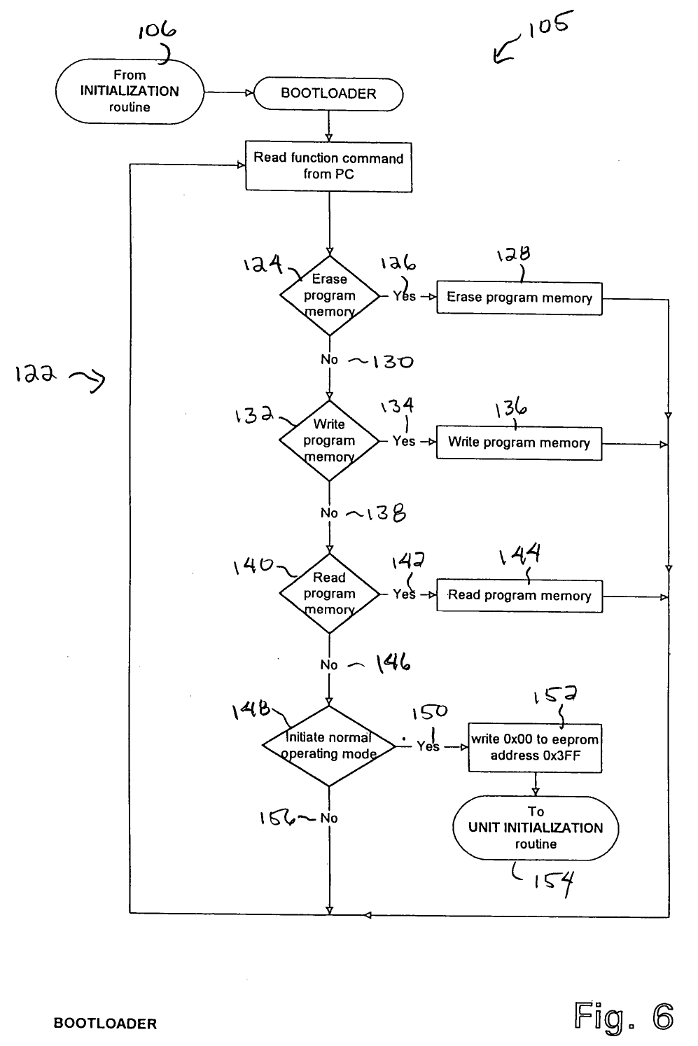

With reference to FIG. 6, the Bootloader routine 105 performs a search loop 122 for a function command. First the search loop looks 124 for an erase program memory command. If an erase program memory command is detected 126, the microprocessor 20 erases 128 the program memory, the command is replaced with an initiate normal operating mode command, and the Bootloader routine 105 returns to the beginning of the search loop 122. If an erase program memory command is not detected 130, the search loop looks 132 for a write program memory command. If a write program memory command is detected 134, the microprocessor 20 writes 136 the program memory, the command is replaced with an initiate normal operating mode command, and the Bootloader routine 105 returns to the beginning of the search loop 122. If a write program memory command is not detected 138, the search loop looks 140 for a read program memory command. If a read program memory command is detected 142, the microprocessor reads 144 the program memory, the command is replaced with an initiate normal operating mode command, and the Bootloader routine 105 returns to the beginning of the search loop 122. If a read program memory command is not detected 146, the search loop looks 148 for a command to initiate the Normal mode. If an initiate normal operating mode command is detected 150, the microprocessor stores 152 “0×00” to EEPROM address 0×3FF and the Bootloader routine 105 exits 154 to the Initialization routine 98. If an initiate normal operating mode command is not detected 156, the Bootloader routine 105 returns to the beginning of the search loop 122.

With further reference to FIG. 4, after initialization has been completed 120, the Main routine 94 queries 158 the operator pad 54 to determine whether any of the multi-purpose buttons 66 of the operator pad 54 is being pressed. If the Main routine 94 determines that one of these buttons is being pressed 160, the Read Keypad routine 162 is initiated 164. If the Main routine determines that one of the multi-purpose buttons is not being pressed 166, the Main routine then queries 168 the operator pad 54 to determine whether the POWER button 56 is being pressed. If the Main routine 94 determines that the POWER button 56 is being pressed 170, the Main routine 94 writes 172 “True” to the Auto-Off address. If the Main routine 94 determines that the POWER button 56 is not being pressed 174, the Main routine 94 queries 176 the Time-Out timer. If no button/key of the operator pad has been pressed within the fifteen (15) minutes prior to the query, the Main routine writes 178 “True” to the Time-Out address. Then the Main routine queries 180 both the Auto-Off address and the Time-Out address, if either address has “True” stored therein 182, the Main routine 94 turns off 184 the meter 10. If neither address has “True” stored therein 186, the Main routine 94 exits 188 to the Update Display routine 190. The meter 10 may be turned off manually by pressing and holding the POWER button 56 until the display screen 50 goes blank.

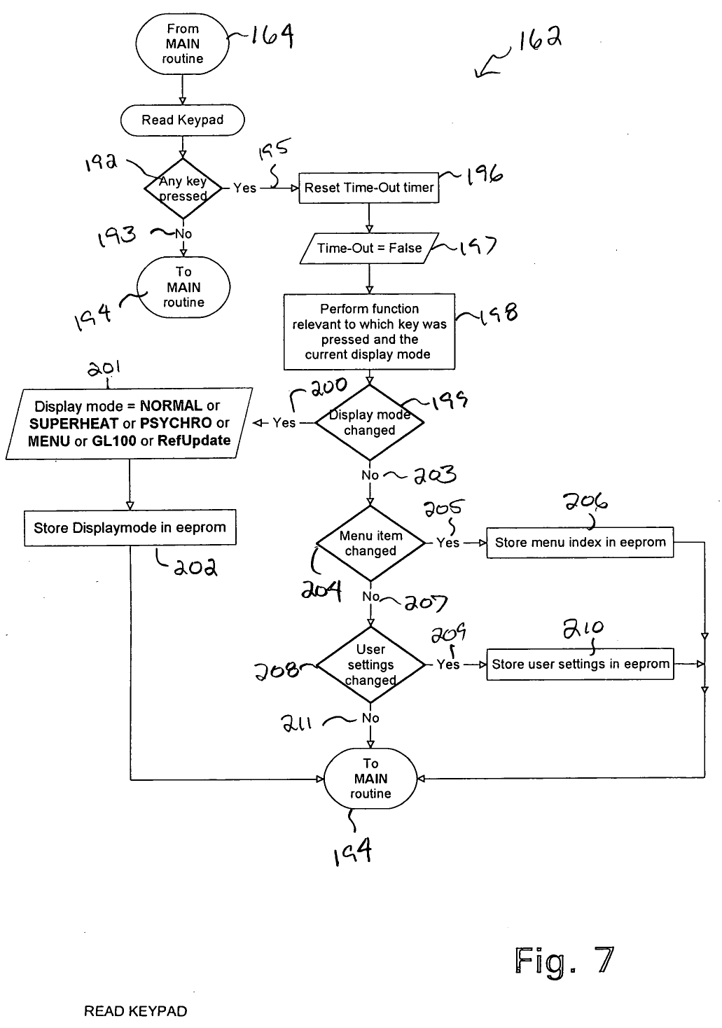

With reference to FIG. 7, the Read Keypad routine 162 first verifies 192 whether one of the multi-purpose buttons 66 is being pressed. If no “pressed” key is detected 193, the Read Keypad routine 162 exits 194 to the Main routine 94. If a “pressed” key is detected 195, the Read Keypad routine 162 resets 196 the Time-Out timer and writes 197 “False” to the Time-Out address. Then the Read Keypad routine 162 initiates 198 a function subroutine associated with such button 66. The Read Keypad routine 162 then determines 199 whether the function subroutine has changed the display mode. If the display mode has been changed 200, the Read Keypad routine 162 writes 201 “Normal”, “Superheat”, Psycho”, “Menu”, “GL100”, or “RefUpdate” (depending on the new mode) to the Display mode address, stores 202 the display mode in memory, and exits 194 to the Main routine 94. If the display mode has not been changed 203, the Read Keypad routine 162 then determines 204 whether the function subroutine has changed the menu item. If the menu item has been changed 205, the Read Keypad routine 162 stores 206 the menu index in memory, and exits 194 to the Main routine 94. If the menu item has not been changed 207, the Read Keypad routine 162 then determines 208 whether the function subroutine has changed the user settings. If the user settings have been changed 209, the Read Keypad routine 162 stores 210 the user settings in memory, and exits 194 to the Main routine 94. If the user settings have not been changed 211, the Read Keypad routine 162 exits 194 to the Main routine 94.

There are several display mode subroutines. The Normal mode: displays the measured values of all the probes then connected to the meter 10, the Superheat/Sub-cooling mode displays the calculated superheat or sub-cooling values for selected refrigerants, and the Psychometrics mode displays calculated psychometric values. The meter 10 will attempt to operate in the last mode it was in when powered off. If it cannot, then Normal mode is the default. If no probes are connected a “No Probes” message will appear on the display screen, and the meter 10 will return to Normal mode.

While in the Normal mode, the meter 10 may display measured values of temperature and/or pressure. To measure temperature, one, two, or three 10 K thermistor probes are plugged into any of the three temperature jacks TI, T2, T3. The meter 10 senses the probe presence and displays the temperature measurement with the appropriate label (T1, T2, or T3) for the jack to which the probe is connected. If two temperature probes are connected, the differential temperature between the two temperature probes may be displayed by pressing and holding the DELTA Button 72 until the word ‘Delta’ appears on the display screen 50. A horizontal bar points to the absolute temperature difference between the two selected temperature measurements. Pressing the DELTA Button 72 again turns off the differential temperature display. If three temperature probes are connected, pressing the DELTA Button 72 again causes the next differential temperature to be displayed. The sequence of the differential temperature displays for three temperature probes is first press: T1-T2; second press: T1-T3; third press: T2-T3; and fourth press: differential temperature display off.

To measure pressure, the signal lead of a pressure transducer connected to the cooling system access port is connected to universal port U1 or U2. Alternatively the signal leads of a pair of pressure transducers connected to cooling system access ports are connected to universal port U1 and U2. The meter 10 senses the probe presence and displays the pressure measurement(s) with the appropriate ‘U1’ or ‘U2’ label. Before connecting the transducer to the cooling system, the pressure reading should be 0 PSI (or 0 kPA if using Metric units). If the reading is not zero, the pressure probe(s) should be zeroed out.

The Superheat/Sub-Cooling subroutine is initiated by pressing the SH Button 80. Pressing the SH Button 80 again causes the microprocessor to return to Normal mode. Measuring system superheat or sub-cooling requires both a temperature probe and a pressure probe. To measure superheat the temperature probe is attached to the system suction line near the compressor and the pressure transducer is attached to the system access port near the low side of the compressor. To measure sub-cooling the temperature probe is attached to the liquid line, and the pressure probe is attached to the high side access port. For superheat measurement, the signal lead of the temperature probe is connected port to T1 and the signal lead of the pressure probe is connected to port U1. For sub-cooling measurement, the signal lead of the temperature probe is connected to port T2 and the signal lead of the pressure probe is connected to port U2. When the SH button 80 is pressed, a refrigerant type is displayed on the display screen 50. The operator must verify that the system refrigerant type is the same as the type shown on the display screen 50. If the system refrigerant type is different, the correct refrigerant type may be selected as described below. The microprocessor 20 determines whether a superheat or sub-cooling calculation is required, based on the jacks used by the temperature and pressure probes (superheat measurements use ports T1 and U1 and sub-cooling measurements use ports T2 and U2), calculates the system superheat/sub-cooling value, and displays the calculated superheat/sub-cooling value along with the actual temperature and pressure readings.

If only a temperature probe may be attached to the cooling system, the superheat/sub-cooling may still be obtained. When the SH button 80 is pressed and a pressure probe is not detected, the meter 10 displays the up/down arrow icon beside a pressure value. The pressure value (from the manifold gauge) can be manually entered by using the UP/DOWN arrow buttons 58, 60. The resulting superheat/sub-cooling value is displayed. When using two temperature probes (T1 and T2), to select which pressure value (P1 or P2) to change, press the SHIFT button 86. The up/down arrow icon will light beside P1 or P2, indicating which value will be changed.

As discussed above, the active refrigerant is displayed when the meter 10 is in the superheat/sub-cooling mode. The active refrigerant is also displayed when viewing the pressure/temperature chart. The active refrigerant is changed by pressing the REF/3 button 88. The up/down arrow icon will appear beside the refrigerant name. The UP/DOWN arrow buttons 58, 60 are used to scroll to the desired refrigerant, and the desired refrigerant is selected by pressing the ENTER button 64 or pressing the REF/3 button 88. The change to the active refrigerant may be abandoned by pressing the CANCEL button 62. Information on fifteen (15) of the most commonly used refrigerants is stored in permanent memory 70. Information on up to five additional refrigerants may be added by using a refrigerant update kit.

The kit consists of an I-button reader, and a refrigerant data tag. The I-button reader is connected to universal port U1 (universal port U2 is not supported). The refrigerant data tag is then inserted in the I-button reader port. The meter 10 detects the tag presence and displays the update menu. By default, all refrigerants listed are marked ‘Y’, indicating that the refrigerants listed in the left column will be replaced by the refrigerants listed in the right column. The number button 66 that corresponds to the refrigerant number in the list is pressed to toggle ‘Y’ or ‘N’. ‘N’ will skip loading that refrigerant. Pressing the ENTER button 64 completes the update. The refrigerant data tag and the I-button reader are then removed. When done, the new refrigerant data will be available for superheat/sub-cooling, as well as viewable in the Pressure/Temperature chart mode. The additional refrigerants may be changed as often as needed.

To measure relative humidity and dry-bulb temperature, a relative humidity probe is connected to either port U1 or port U2 (or both). The meter 10 senses the probe presence and displays the relative humidity and dry-bulb temperature measurements with the appropriate U1 or U2 label. To display psychometric data, a relative humidity probe must be installed in either port U1 or port U2 (or both). The Psychometrics mode is initiated by pressing the PSYCH button 82 and pressing the PSYCH button 82 again returns the meter 10 to the Normal mode.

Minimum, maximum and average values of the sensed environmental parameters may also be displayed. When in the Normal mode, pressing the MIN button 76 causes the lowest readings sensed by each probe to be displayed; pressing the MAX button 78 causes the highest readings sensed by each probe to be displayed; and pressing the AVG button 74 causes the average readings sensed by each probe to be displayed. The active mode MIN, MAX or AVG, are indicated near the bottom of the display. Pressing the same button again turns off the selected mode. Disconnecting a probe will clear that probe's MIN, MAX, AVG memory, but all probes still connected will continue to be updated. All MIN MAX, AVG memory is lost when the meter 10 is powered down.

Additional functions and settings are available through the meter 10 menu windows. Pressing the MENU button 84 causes the microprocessor 20 to display the top-level menu. The UP/DOWN arrow buttons 58, 60 are used to select one of the menu options, and the selected option is initiated by pressing the ENTER button 64. Some menu items lead to sub-menus. From a sub-menu, pressing the MENU button 84 causes the display to go back to the previous menu. At any time, pressing the CANCEL button 62 causes the meter 10 to exit the menu window and return to the previous display mode.

The Main Menu window includes five (5) functions. Adjust Contrast allows the display screen contrast to be changed to suit the ambient lighting situation. The UP/DOWN arrow buttons 58, 60 are used to set the contrast and pressing the ENTER button 64 saves the change. The changes may be abandoned by pressing the CANCEL button 62. View GL100 Log allows the user to access up to five Cooper GL100 data logger downloads stored in memory 70. Pressure/Temp Chart allows the user to view the pressure vs. temperature chart for the active refrigerant. Hide/Show Elapsed Time allows the user to turn off the display of the elapsed time normally provided while in Normal mode by selecting this menu item and then pressing the ENTER button 64. If disabled, the menu item will be shown as “Show Elapsed Time”. If enabled, the menu item will be shown as “Hide Elapsed Time”. Auto Shutoff automatically powers-off the meter 10 after 15 minutes of inactivity (inactivity is defined as no keys/buttons pressed in 15 minutes). Disable/Enable Auto Shutoff allows the user enable or disable the Auto Shutoff routine. To toggle Auto Shutoff, the UP/DOWN arrow buttons 58, 60 are used to highlight this menu item, and then the ENTER button 64 is pressed. When disabled, this menu item will be shown as, “Enable Auto Shutoff”. When enabled, the menu item will be shown as “Disable Auto Shutoff’. Auto Shutoff is enabled whenever the meter 10 is powered on.

The Setup Menu window includes four (4) functions. Set Altitude allows the user to enter a value for the current altitude in 500-foot increments with the UP/DOWN arrow buttons. Units of Measure allows the user to select either English or Metric units of measure. Temperature Cal allows the user to calibrate a temperature probe by placing the temperature probe connected to T1 into a known temperature and adjusting the reading to match. Zero out Probe P1 & P2 allow the user to zero a pressure probe is attached to U1 or U2 if the probe reading is not 0 psi before the probe is connected to a system.

The meter 10 may also be used with a Cooper GL100 Data Logger by connecting an I-button reader port to U1 and attaching the GL100 to the I-button reader port. The meter 10 detects the GL100 presence and displays the GL100 Data logger Menu. If the GL100 has been previously programmed for a mission, the mission description is displayed. Below the mission description are the GL100 Menu options. The UP/DOWN arrow buttons 58, 60 are used to scroll to the desired menu option, and the menu option is selected by pressing the ENTER button 64. The GL100 Menu includes four (4) options. Check Settings is used to view the current mission status. The status screen displays the following data: mission description; sampling status (active or stopped); sample interval (time between samples); mission start time and date; action on data logger full (stop or rollover); and record count. Pressing any key returns the display to the GL100 Data Logger Menu.

Program a Mission allows a user to re-program and launch the GL100 on a new mission. The mission programming steps include entering a mission description of up to 20 alphanumeric characters. A symbol in the lower-left corner of the display indicates whether letters or numbers are entered (‘ABC’ indicates letters, ‘1 2 3’ indicates numbers). Switching between letters and numbers is effected by pressing the SHIFT button 86. A sampling interval (the time between samples) is set using the number buttons 66. The minimum interval is 1 minute and the maximum interval is 255 minutes. The action to take when the data logger has reached the end of its storage memory (When Full) is set using the UP/DOWN arrow buttons to scroll to the desired action and then pressing the ENTER button 64. The current time and date in the GL100 internal clock is set (Set GL100 Clock) using the number buttons 66 and the UP/DOWN arrow buttons 58, 60. Finally the mission programming is confirmed by pressing the ENTER button 64 or abandoned by pressing the CANCEL button 62.

Download Data allows the user to store the data logger contents in the memory of the meter 10, and then view such data at a later time. View Data allows the user to view the GL100 mission data contained in the GL100. The data is displayed in two ways: as a graph of the temperature data points, and as discrete data at the bottom of the display. The UP/DOWN arrow buttons 58, 60 are used to move a cursor. As the cursor moves, the temperature, time, date data pointed to by the cursor is displayed below the cursor line.

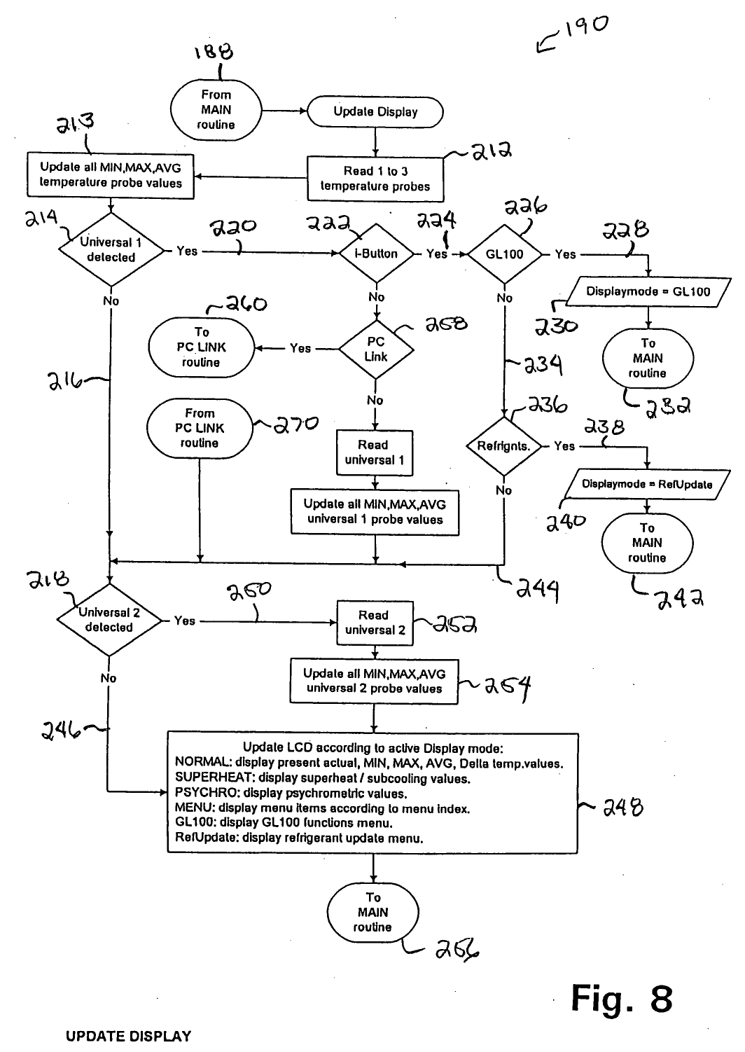

With reference to FIG. 8, the Update Display routine 190 initially queries 212 each temperature probe that is installed to obtain a measured value of the sensed temperature and updates 213 the minimum, maximum and average temperature values for each of the probes. Next, the microprocessor 20 determines 214 if an instrument is installed at universal port U1. If an instrument is not detected 216, the microprocessor 20 determines 218 if an instrument probe is installed at universal port U2.

If the microprocessor 20 detects 220 the presence of an installed instrument, it queries 222 universal port U1 to determine whether the instrument is an I-button reader. If an I-button reader is detected 224, the microprocessor 20 then queries 226 universal port U1 to determine whether a Cooper GL100 Data Logger is connected to the I-button data port. If a Cooper GL100 Data Logger is connected 228 to the I-button reader, the microprocessor sets 230 Displaymode=GL100 and exits 232 to the Main routine 94. If a Cooper GL100 Data Logger is not connected 234 to the I-button reader, the microprocessor 20 then queries 236 universal port U1 to determine whether a refrigerant data tag is inserted in the I-button data port. If a refrigerant data tag is detected 238, the microprocessor sets 240 Displaymode=RefUpdate and exits 242 to the Main routine 94. If a refrigerant data tag is not detected 244, the microprocessor determines 218 if a probe is installed at universal port U2.

If the microprocessor 20 does not detect 246 an installed probe, it updates 248 the data displayed at the display screen 50 according to the active display mode and then exits 256 to the Main routine 94. If the microprocessor detects 250 the presence of an installed probe, the microprocessor queries 252 the probe to obtain a measured value of the sensed environmental variable and updates 254 the minimum, maximum and average values for the probe. Next, the microprocessor 20 updates 248 the data displayed at the display screen according to the active display mode and then exits 256 to the Main routine 94.

If “Normal” is stored in Displaymode, the microprocessor displays the current actual, minimum, maximum, average and/or differential temperature values. If “Superheat” is stored in Displaymode, the microprocessor displays the current superheat/sub-cooling values. If “Psycho” is stored in Displaymode, the microprocessor displays the current psychometric values. If “Menu” is stored in Displaymode, the microprocessor displays the menu items according to the menu index. If “GL100” is stored in Displaymode, the microprocessor displays the Cooper GL100 functions menu. If “RefUpdate” is stored in Displaymode, the microprocessor displays the refrigerant update menu.

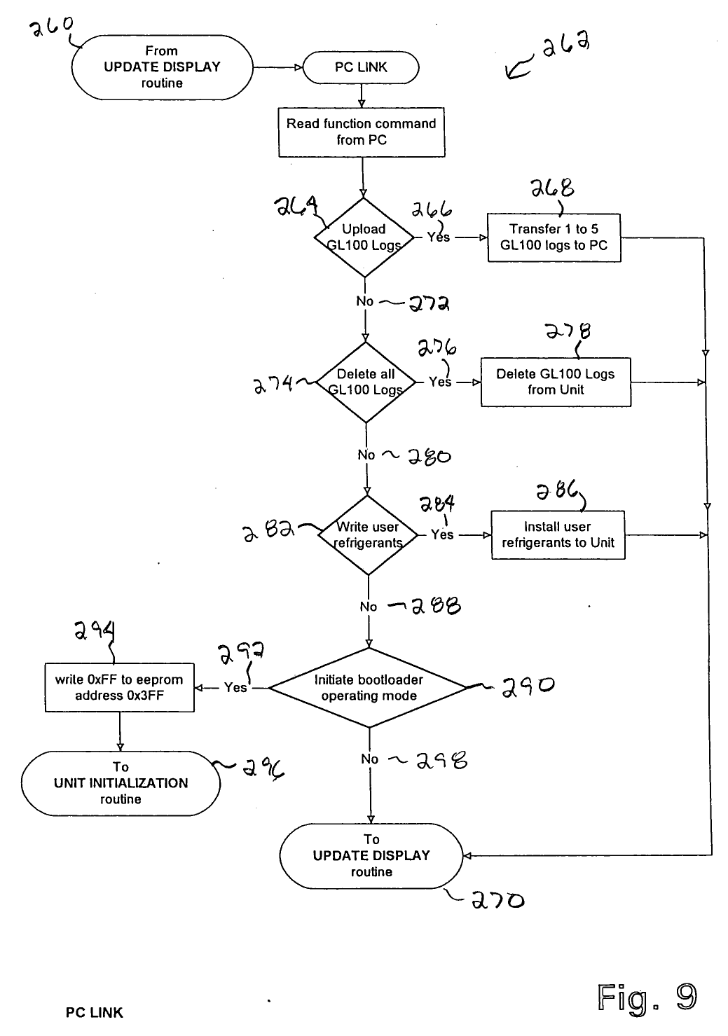

With reference to FIG. 9, a personal computer (PC) may be linked to the meter 10 by connecting the PC to universal port U1. The microprocessor 20 will detect 258 the link during the Update Display routine 190 and initiate 260 the PC Link routine 262 (FIG. 8). The PC Link routine 262 initially queries 264 the PC for an Upload GL100 logs command. If an Upload GL100 logs command is found 266, the microprocessor transfers 268 one to five GL100 logs to the PC and then initiates 270 the Update Display routine 190. If an Upload GL100 logs command is not found 272, the microprocessor queries 274 the PC for a Delete GL100 logs command. If a Delete GL100 logs command is found 276, the microprocessor deletes 278 the GL100 logs from memory and then initiates 270 the Update Display routine 190. If a Delete GL100 logs command is not found 280, the microprocessor queries 282 the PC for a Write User Refrigerants command. If a Write User Refrigerants command is found 284, the microprocessor stores 286 the user refrigerant information in memory 70 and then initiates 270 the Update Display routine 190. If a Write User Refrigerants command is not found 288, the microprocessor queries 290 the PC for an Initiate Bootloader Operating Mode command. If an Initiate Bootloader Operating Mode command is found 292, the microprocessor stores 294 “0×FF” to EEPROM address 0×3FF and initiates 296 the Initialization routine 98. If an Initiate Bootloader Operating Mode command is not found 298, the microprocessor initiates 270 the Update Display routine 190.

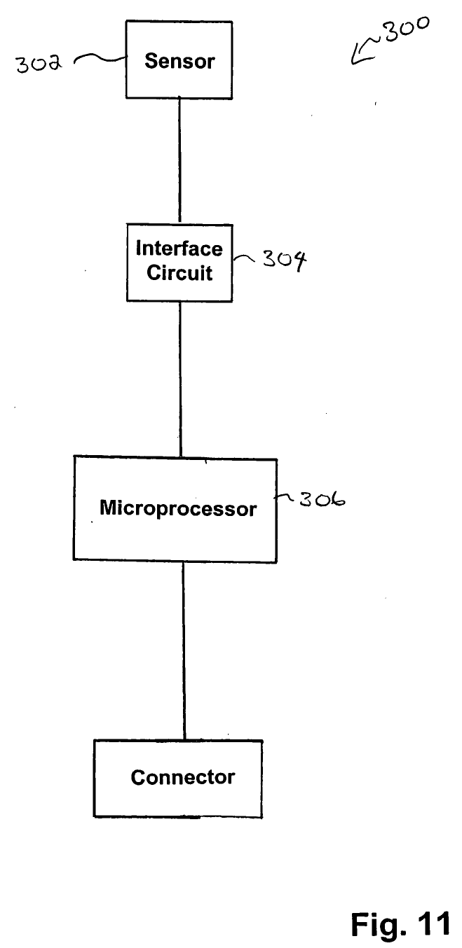

With reference to FIG. 11, special function probes 300 (Smart Probes™) operate in conjunction with the multi-function meter 10 to sense and measure particular environmental conditions, which may include temperature, relative humidity, pressure, airflow, etcetera, as they relate to the HVAC/R equipment being tested. Each probe 300 includes one or more specific sensors 302, and interface circuitry 304 that reads the sensor signal(s), and relays the signal information to the multi-function meter 10 through one of the universal ports 68. Power for the probe circuitry 304 is provided by the multi-function meter 10 universal port connector 68. The special function probe 300 may also use the measured (sensed) values to derive additional parameters based upon calculations performed within its on-board microprocessor 306, and report these to the multi-function meter 10 as well. When not communicating with the meter 10, the probe 300 is continuously sensing and updating its values in preparation for the next request from the meter 10. Each type of special function probe 300 transmits a set number of parameters to the meter 10. For example, a humidity probe provides 6 signals, 2 measured values and 4 calculated values, while the pressure probe transmits only one measured value.

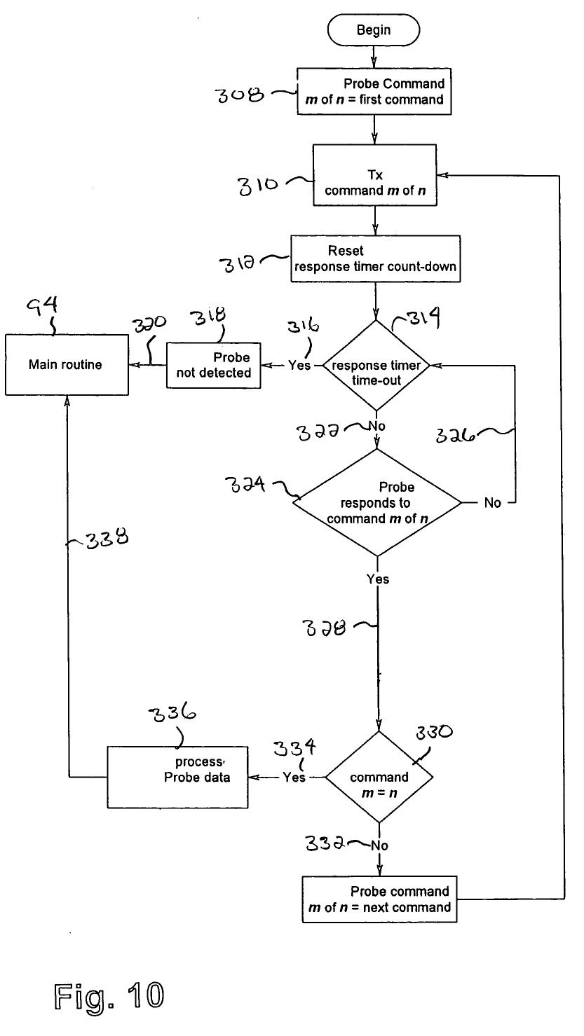

Communication between the multi-function meter 10 and the special function probe 300 is initiated by the meter 10, and consists of a series of commands or queries transmitted by the meter 10 and responses from the probe, as shown in FIG. 10. Since each type of probe 300 transmits a different number of parameters to the meter 10, the first command 308 (m of n=first command) transmitted 310 by the meter 10 prompts the special function probe 300 to identify the probe type. The operating software then resets 312 the response timer, initiates count-down, and then queries 314 if the response timer has timed-out. If the response timer has timed-out 316 at this point and a response has not been received 318 from a probe 300, the meter 10 assumes that a functional special function probe is not connected to the universal port 68 and the operating software returns 320 to the Main routine 94. If the response time has not timed out 322, the operating software then queries 324 whether a response has been received from a special function probe 300. If a response has not been received 326, the operating software again queries 314 whether the response timer has timed-out. If a response has been received 328, the operating software determines 330 whether all queries associated with the specific probe type have been transmitted. As described above, the first response received from the probe 300 is an identification of the type of probe, thereby identifying the number of queries required to obtain all of the probe data. In the example of the humidity probe, the meter 10 must transmit 6 queries to extract all of the data from the humidity probe. Accordingly, “n” for a humidity probe is equal to 7 (the initial identity query plus the 6 data queries). If not all of the queries have been transmitted 332 (m<n), the meter 10 transmits 310 the next query (m of n=next command). If all of the queries have been transmitted 334 (m=n), the operating software processes 336 the data received from the probe 300 and returns 338 to the Main routine 94.

While preferred embodiments have been shown and described, various modifications and substitutions may be made thereto without departing from the spirit and scope of the invention. Accordingly, it is to be understood that the present invention has been described by way of illustration and not limitation.

What is claimed is:

1. A multi-function meter system comprising:
a hand-held meter including:
a housing having a front face,
an electronic assembly housed within the housing and including
a circuit board,
a microprocessor in electrical communication with the circuit board, and
a memory device in electrical communication with the circuit board, the memory device having an operating system stored therein,
a power supply housed within the housing and in electrical communication with the circuit board,
a display screen in electrical communication with the circuit board,
an operator pad in electrical communication with the circuit board, and
a plurality of data ports, each of the data ports being in communication with the circuit board; and
an environmental probe in communication with an associated one of the data ports, the environmental probe sensing a selected environmental parameter;
wherein the operating system identifies the environmental parameter sensed by the environmental probe, or transmits a query to the display screen requesting that the environmental parameter sensed by the environmental probe be identified to the operating system through the operator pad, and provides at least one measured value of the identified environmental parameter on the display screen.

2. The multi-function meter system of claim 1 wherein the display screen is a liquid crystal display screen disposed within the housing, the front face of the housing defines an opening, and the housing also has a window sealing the opening, for viewing the display screen.

3. The multi-function meter system of claim 1 wherein the operator pad includes a POWER touch control button, an UP ARROW touch control button, a DOWN ARROW touch control button, a CANCEL touch control button, an ENTER touch control button, and a plurality of multi-use numeric/function keys.

4. The multi-function meter system of claim 1 wherein the data ports include two universal ports and three temperature ports.

5. The multi-function meter system of claim 4 wherein each of the universal ports is a 5 pin DIN connector.

6. The multi-function meter system of claim 1 wherein the environmental probe is selected from temperature probes, humidity probes, pressure probes, and airflow probes.

7. The multi-function meter system of claim 6 wherein for a humidity probe, the measured value displayed on the display screen is selected from wet bulb value, dry bulb value, specific humidity value, % relative humidity value, enthalpy value, and dew point value.

8. The multi-function meter system of claim 6 wherein for a pressure probe, the measured value displayed on the display screen has a pressure range of 0 to 1000 psi.

9. The multi-function meter system of claim 1 wherein the environmental probe includes:
a jack connectable to an associated one of the meter data ports;
at least one environmental sensor;
a microprocessor; and
interface circuitry providing electrical communication between the at least one sensor, the microprocessor and the jack.

10. The multi-function meter system of claim 1 wherein the housing also has
a rear face disposed opposite to the front face;
a hook member having
a straight end portion pivotally mounted to the rear face and
a hook portion adapted for suspending the meter from an external structure; and
a catch mounted to the rear face engagable with the hook member to hold the hook portion against the rear face.

11. The multi-function meter system of claim 10 wherein the rear face defines a rear surface and the housing further has a plurality of corners and a foot extending from each corner rearwardly beyond the hook member.

12. The multi-function meter system of claim 1 wherein the housing also has:
oppositely disposed end panels;
oppositely disposed side panels; and
a boot composed of resilient material, the boot covering at least portions of the side panels and the end panels.

13. The multi-function meter system of claim 12 wherein the housing further has upper, lower and mid sections and each of the side panels has an arcuate shape, the mid section of the housing defining a narrower shape than the upper and lower sections of the housing.

14. A method of measuring multiple environmental parameters with a single multi-function meter system, the meter system including a hand-held meter and an environmental probe for sensing a selected environmental parameter; the meter including a housing, an electronic assembly housed within the housing and including a circuit board, a microprocessor in electrical communication with the circuit board, and a memory device in electrical communication with the circuit board, the memory device having an operating system stored therein, a display screen in electrical communication with the circuit board, an operator pad in electrical communication with the circuit board, and a plurality of data ports, a one of the data ports providing communication between the environmental probe and the circuit board; the method comprising the steps of:
transmitting a signal from the environmental probe to the meter, the signal being proportional to the sensed environmental parameter;
identifying the environmental parameter within the meter microprocessor;
computing at least one measured value specific to the identified environmental parameter with the operating system; and
displaying the at least one measured value of the identified environmental parameter on the display screen.

15. The method of claim 14 wherein the data ports of the meter include at least one temperature probe port and at least one universal port, the step of identifying the environmental parameter comprising:
the microprocessor querying the at least one temperature probe port for signals from any environmental probe connected thereto; and
if no signal is detected, the microprocessor querying the at least one universal port for signals from any environmental probe connected thereto.

16. The method of claim 15 wherein when the meter microprocessor detects an environmental probe connected to the at least one temperature probe port, the meter microprocessor then computing a minimum temperature value, a maximum temperature value, and an average temperature value for each environmental probe connected to the at least one temperature probe port.

17. The method of claim 14 wherein the meter system also includes an I-button reader and wherein the method also comprises:
the meter microprocessor querying the at least one universal port for the presence of the I-button reader;
if the I-button reader is detected, the meter microprocessor querying the at least one universal port to determine whether a data logger is connected to the I-button data port.

18. The method of claim 17 wherein the meter microprocessor detects a data logger connected to the I-button data port, the meter microprocessor then
displaying a data logger menu and
enabling at least one option provided in the data logger menu.

19. The method of claim 17 wherein the meter microprocessor does not detect a data logger connected to the I-button data port, the meter microprocessor then querying the at least one universal port to determine whether a refrigerant data tag is inserted in the I-button data port.

20. The method of claim 15 wherein the meter microprocessor detects a special function probe connected to the at least one universal port, the special function probe having a predetermined probe type, each probe type providing a predetermined number of parameter signals, the meter microprocessor then
transmitting a first command to the special function probe prompting the special function probe to identify the probe type;
determining the number of parameter signals associated with the identified probe type; and
transmitting a subsequent command for each of the parameter signals associated with the identified probe type.

21. The method of claim 14 wherein the step of displaying the at least one measured value includes:
displaying the measured values of all of the environmental probes connected to the meter data ports, or
displaying calculated superheat or sub-cooling value for selected refrigerants, or
displaying calculated psychometric values.

22. The method of claim 15 further comprising the step of linking a personal computer to the at least one universal port of the meter, the meter microprocessor then detecting the personal computer and initiating a PC Link routine.

23. The method of claim 22 wherein the PC Link routine:
first queries the personal computer for an upload data logger logs command;
transferring data logger logs to the personal computer if an upload data logger logs command is found;
querying the personal computer for a delete data logger logs command if an upload data logger logs command is not found;
deleting data logger logs if a delete data logger logs command is found;
querying the personal computer for a write user refrigerants command if a delete data logger logs command is not found;
storing user refrigerant information in the microprocessor if a write user refrigerants command is found; and
exits the PC Link routine if a write user refrigerants command is not found.
